(19) United States
(12) Patent Application Publication
(10) Pub. No.: US 2004/0128787 A1
(43) Pub. Date: Jul. 8, 2004

(54) Windshield wiper blade slapper apparatus

(76) Inventor: William J. Wagner, Petawawa (CA)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/740,495

(22) Filed: Dec. 22, 2003

(30) Foreign Application Priority Data
Dec. 23, 2002 (CA) 2,415,049

(51) Int. Cl. B60S 1/32; B60S 1/04

(52) U.S. Cl. 15/250.19; 15/250.351

(57) ABSTRACT

A windshield wiper arm apparatus for slapping a windshield wiper blade against a windshield to remove ice or snow therefrom has a solenoid and an activating push-pull rod with its free end attached to the underside of the wiper blade base to lift the wiper blade off the windshield and slap it against the windshield.

### FIELD OF THE INVENTION

The present invention relates to the removal of ice, snow and other debris from windshield wiper blades.

### PRIOR PROPOSALS

It has previously been proposed to provide apparatus for lifting a wiper blade from a windscreen and letting it slap down on the windshield so as to remove ice or snow therefrom. One such proposal used a complicated level assembly whilst another system involved the use of apparatus to lift the wiper blade by a connection on top of the wiper blade housing. Such a connection would apparently result in a less efficient lifting and slapping operation than is ideal and cause unnecessary stresses on the apparatus.

### SUMMARY OF THE INVENTION

It is an object of the present invention to overcome, or substantially reduce the disadvantages of the prior proposals. There is provided a windshield wiper arm apparatus for a vehicle for lifting and slapping a windshield wiper blade against a windshield, said apparatus comprising a wiper base mounted on a drive hub for operation about a drive axis, a wiper arm pivotally connected to said wiper base for movement about a pivot axis, said pivotal connection allowing said wiper arm to pivot away from and towards a given position, a solenoid casing having a closed end and an open end with the closed end mounted on said drive hub, an activating push-pull rod protruding from said open end of the solenoid casing, with the free end of said push-pull rod attached to the underside of said wiper base, a solenoid within said solenoid casing associated with the push-pull rod to control movement of the push-pull rod, a spring connected to said wiper base and to said wiper arm to place said wiper arm under tension, switch means within the body of said vehicle connected through electrical wiring to said solenoid so that on momentary closing of said switch, electric current is applied to the solenoid whereby said push-pull rod is forced outwards and upwards to lift said wiper blade off said windshield, cessation of said electric current though said solenoid causing said wiper blade to slap against said windshield with a spring snapping action.

### BRIEF DESCRIPTION OF THE DRAWINGS

An embodiment of the invention will now be described, by way of example, with reference to the accompanying drawings in which:

FIG. 1 is a diagrammatic representation in side view of the windshield wiper apparatus according to an embodiment of the invention in a resting position;

FIG. 2 is a diagrammatical representation in plan view of the windshield wiper assembly of FIG. 1 in an activated position; and

FIG. 3 is a diagrammatical representation in side view of part of FIG. 1 on an enlarged scale.

### DESCRIPTION OF THE PREFERRED EMBODIMENT

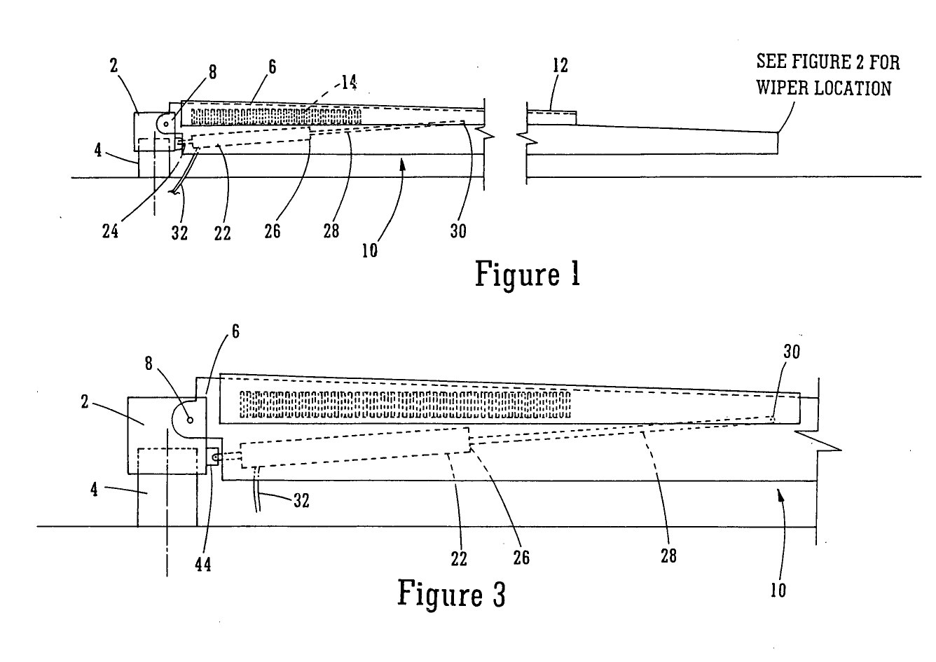

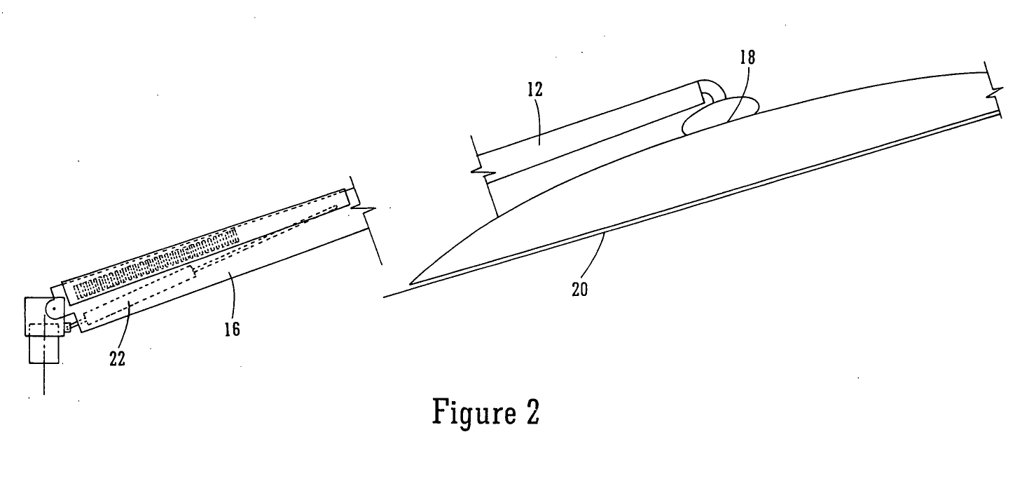

Referring to the figures, a windshield wiper drive hub 2 is mounted on a car spindle 4 and a windshield wiper base 6 is pivotally mounted at a pivotal connection 8. The wiper base 6, forming part of a windshield wiper assembly 10 and a wiper arm 12 is shown in FIGS. 1 and 2. A spring 14 is shown and provides tension between windshield wiper base 6 and the wiper arm 12.

In FIG. 2 it will be seen that the wiper arm 12 is connected to the wiper blade assembly 16. A wiper blade 18, in use is swept over windshield 20 to remove rain, ice and snow therefrom. However, ice and snow sometime adheres to the blade 18 and interferes with its movement and efficiency in wiping the windshield 20.

Blowing warmed air on to the inside of the windshield does help but, in FIGS. 1 and 2, a solenoid casing 22 is shown having one fixed closed end 24 and a second open end 26. An electrical solenoid, not shown, is provided within the solenoid casing 22 with an activating push-pull rod 28 protruding from the open end 26. When the solenoid is energized, rod 28 is pushed outwards and upwards and when the solenoid is de-energized the rod 28 is retracted.

Free end 30 of rod 28 is attached to the base 6.

Electrical wires 32 for the solenoid in casing 22 are routed through a small hole in the body of the car if it is an after-market installation. In the case of a new manufacture the wires 32 may pass through the drive spine and hub assembly. Activation of the solenoid in casing 22 is achieved by providing a paddle switch (not shown) on the wiper controls on the steering column of the vehicle. Alternatively a push button can be provided on the dash.

The hub of the wiper arm is increased in size to allow room for the solenoid casing 22 and the angle is made perpendicular to the windshield. The angle and height of the hub are increased from the original. The wiper base will also incorporate the spring 14 normally part of the wiper assembly. The bigger hub will not change the angle.

As can be seen, the solenoid in casing 22 is mounted on the drive hub of the wiper, at its stationary point, and to the arm itself.

In use, when the paddle, or push button, is pressed then the corresponding momentary contact switch is closed which causes the solenoid in casing 22 to be energized whereby rod 28 is extended. This extension causes the wiper arm 12 to be pushed so as to move upwards whereby the wiper blade 18 is raised off the windshield. Since the respective switch is momentary contact the solenoid in casing 22 is only energized for a moment. When the solenoid in casing 22 is de-energized the spring 14 associated with the wiper arm 12 will bring the blade 18 down onto the windshield 20 with a sharp slap to break off any snow, ice or other debris which may have collected on the wiper blade 18.

While the invention has been described with reference to specific embodiments, modifications and variations of the invention may be constructed without departing from the scope of the invention, which is defined in the following claims.

1. A windshield wiper arm apparatus for a vehicle for lifting and slapping a windshield wiper blade against a windshield, said apparatus comprising:
a) a wiper base mounted on a drive hub for operation about a drive axis,
b) a wiper arm pivotally connected through a pivotal connection to said wiper base for movement about a pivot axis, said pivotal connection allowing said wiper arm to pivot away from and towards a given position,
c) a solenoid casing having a closed end and an open end with the closed end mounted on said drive hub,
d) an activating push-pull rod protruding from said open end of the solenoid casing, with the free end of said push-pull rod attached to the underside of said base,
e) a solenoid within said solenoid casing associated with the push-pull rod within the casing to control movement of the push-pull rod,
f) a spring connected to said wiper base and to said wiper arm to place said wiper arm under tension,
g) switch within the body of said vehicle connected through electrical wiring to said solenoid so that on momentary closing of said switch, electric current is applied to the solenoid for forcing said push-pull rod outwards and upwards to lift said wiper blade off said windshield,
h) said solenoid being arranged so that in response to cessation of said electric current through said solenoid, said wiper blade is arranged to slap against said windshield with a spring-snapping action.

2. Apparatus according to claim 1 wherein said switch means comprises a paddle switch on a wiper control of said vehicle.

3. Apparatus according to claim 2 wherein said open end of said casing is mounted on said base.

4. Apparatus according to claim 1 wherein said switch comprises a push button on a dash of said vehicle.

5. Apparatus according to claim 4 wherein said open end of said casing is mounted on said base.

6. Apparatus according to claim 1 wherein said open end of said casing is mounted on said base.
